(19) United States
(12) Patent Application Publication
(10) Pub. No.: US 2007/0263671 A1
(43) Pub. Date: Nov. 15, 2007

(54) STATE SYNCHRONIZATION APPARATUSES AND METHODS

(75) Inventors: Chih-Lin Hu, Tainan City (TW); Wei Nan Tseng, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/746,561

(22) Filed: May 9, 2007

(30) Foreign Application Priority Data
May 12, 2006 (TW) TW95116878

(51) Int. Cl. H04J 3/06

(52) U.S. Cl. 370/503

(57) ABSTRACT

A method for state synchronization, performed by a first electronic apparatus, comprises the following steps. A first service state version identification (ID) is acquired from a local cache of the first electronic apparatus. A second service state version ID is received from a second electronic apparatus. It is determined whether the first service state version ID is older than the second service state version ID. If so, a current service state value and a third service state version ID corresponding to the current service state value are acquired by querying a service resident on a third electronic apparatus. The first, second and third electronic apparatuses are organized in an event casting tree. The third electronic apparatus is a root node of the event casting tree, and the first and second electronic apparatuses are leaf nodes of the event casting tree.

### BACKGROUND

The invention relates to state synchronization, and more particularly, to state synchronization apparatuses and methods in a large-scale distributed network environment.

Devices in distributed environments may share common states for service coordination and collaboration, particularly in event-driven service management systems. In general, in service management systems, notifications of changes of service states may be processed asynchronously: a service (or an administration console) sequentially notifies all devices of all changed common states. The values of the common state are stored (or cached) in the devices. The devices, however, maintain cached common states in different ways, and thus, may have inconsistent common state values, thereby causing failure of service coordination.

### SUMMARY

Methods for state synchronization, performed by a first electronic apparatus, are provided. An embodiment of a method for state synchronization comprises the following steps. A first service state version identification (ID) is acquired from a local cache of the first electronic apparatus. A second service state version ID is received from a second electronic apparatus. It is determined whether the first service state version ID is older than the second service state version ID. If so, a current service state value and a third service state version ID corresponding to the current service state value are acquired by querying a service resident on a third electronic apparatus. The first, second and third electronic apparatuses are organized in an event casting tree. The third electronic apparatus is a root node of the event casting tree, and the first and second electronic apparatuses are leaf nodes of the event casting tree.

An embodiment of a method for state synchronization comprises the following steps. An upward check request is received from a second electronic apparatus, the upward check request comprising a first service state version ID. A second service state version ID stored in a local cache of the first electronic apparatus is acquired. An upward check procedure and a downward check procedure are selectively activated according to a comparison result between the first service state version ID and the second service state version ID. The first and second electronic apparatuses are organized in an event casting tree. The first electronic apparatus is a parent node of the second electronic apparatus. The upward check procedure transmits the upward check request to an electronic device causing inconsistency between the first and second service state version IDs. The downward update procedure downwardly notifies all nodes directly or indirectly connecting to the first electronic apparatus of information indicating storage of a first service state value corresponding to the first service state version ID.

An embodiment of a method for state synchronization comprises the following steps. A downward update request is received from a second electronic apparatus; the downward update request comprises a first service state version ID and a service state value corresponding to the first service state version ID. A second service state version ID and a second service state value in a local cache of the first electronic apparatus are respectively replaced with the first service state version ID and the first service state value. The first and second electronic apparatuses are organized in an event casting tree. The first electronic apparatus is a child node of the second electronic apparatuses.

Systems for state synchronization are provided. An embodiment of a system for state synchronization comprises a first, second and third electronic apparatuses. The first electronic apparatus comprises a service. The first, second and third electronic apparatuses are organized in an event casting tree. The first electronic apparatus represents a root node of the event casting tree, the second electronic apparatus represents a relay node of the event casting tree, and the third electronic apparatus represents a leaf node of the event casting tree. The third electronic apparatus subscribes multiple event notifications to the service. The first electronic apparatus hierarchically transmits the event notifications in sequence to the third electronic apparatus via the second electronic apparatus.

### BRIEF DESCRIPTION OF DRAWINGS

The invention will become more fully understood by referring to the following detailed description with reference to the accompanying drawings, wherein:

FIG. 1 is a diagram of network architecture of an embodiment of a state synchronization system;

FIG. 2 is a diagram of a hardware environment applicable to an embodiment of a personal computer;

FIG. 3 is a diagram of an embodiment of a distributed event dissemination mechanism;

FIG. 4 is a diagram of state inconsistency among leaf nodes;

FIG. 5 is a flowchart of an embodiment of a state synchronization method executed by a leaf node;

FIG. 6 is a flowchart of an embodiment of a state synchronization method executed by a relay node or the root node;

FIG. 7 is a flowchart of an embodiment of a state synchronization method executed by a relay node or a leaf node;

FIG. 8 is a diagram of an embodiment of a finite state automata of a state synchronization;

FIG. 9 is a diagram of an embodiment of a storage medium storing a computer program for state synchronization;

FIG. 10 is a diagram of exemplary state synchronization;

FIG. 11 is a diagram of exemplary state synchronization.

### DETAILED DESCRIPTION

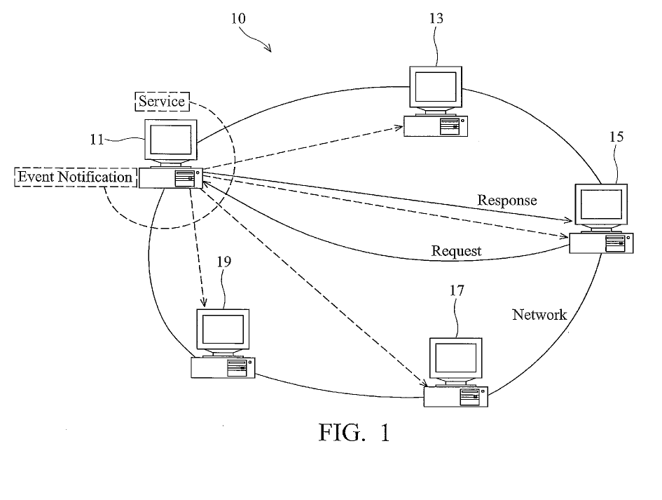

FIG. 1 is a diagram of network architecture of an embodiment of a state synchronization system 10, comprising personal computers 11, 13, 15, 17 and 19. The personal computers 11, 13, 15, 17 and 19 operate in a wired or wireless network or a combination thereof to connect therebetween. Those skilled in the art will recognize that the personal computers 11, 13, 15, 17 and 19 may be connected in different types of networking environments, and may communicate therebetween through various types of transmission devices such as routers, gateways, access points, base station systems or others. The state synchronization system 10 employs a publisher-subscriber (or push) model to notify connected computers of state changes. Specifically, the personal computer 11 advertises services thereof in a network, enabling personal computers 13, 15, 17 and 19 to discover and to subscribe the advertised services. The personal computer 11 operates as a state source for transmitting event notifications respectively comprising service state values to personal computers 13, 15, 17 and 19 in an asynchronous manner. The personal computers 13, 15, 17 and 19 may subscribe to the published service resident on the personal computer 11 (i.e. the publisher) prior to subsequently receiving event notifications indicating state changes of the subscribed service. When multiple personal computers subscribe to the same service, the personal computer 11 may transmit event notifications to the subscribing personal computers by unicasting, multicasting or broadcasting, and subsequently, the subscribing personal computers store service state values in their local caches. In addition, the subscribing personal computers can request service state values and replace cached service state values with service state values in a corresponding response. Note that the personal computer 11 further transmits a valid duration indicating the duration of each corresponding service state value.

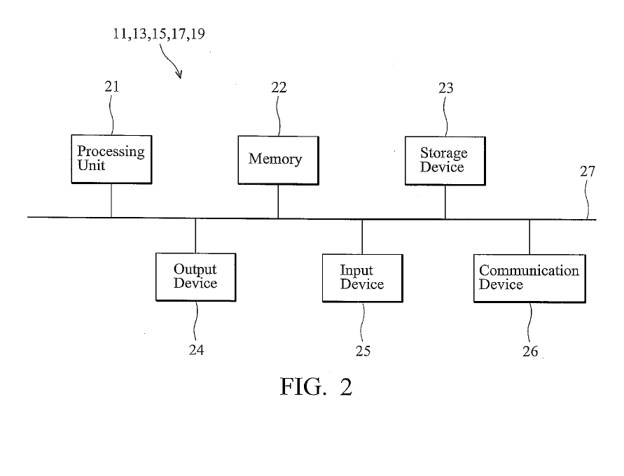

FIG. 2 is a diagram of a hardware environment applicable to an embodiment of personal computer 11, 13, 15, 17 or 19, comprising a processing unit 21, memory 22, a storage device 23, an output device 24, an input device 25 and a communication device 26. The processing unit 21 is connected by buses 27 to the memory 22, storage device 23, output device 24, input device 25 and communication device 26 based on Von Neumann architecture. There may be one or more processing units 21, such that the processor of the computer comprises a single central processing unit (CPU), a microprocessing unit (MPU) or multiple processing units, commonly referred to as a parallel processing environment. The memory 22 is preferably a random access memory (RAM), but may also include read-only memory (ROM) or flash ROM. The memory 22 preferably stores program modules executed by the processing unit 21 to perform state synchronization functions. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. The programmable consumer electronics may be mobile stations, projectors, displays, mp3 players, personal digital assistants (PDAs), digital video recorders and the like. Some embodiments may also be practiced in distributed computing environments where tasks are performed by remote processing devices linked through a communication network. In a distributed computing environment, program modules may be located in both local and remote memory storage devices based on various remote access architectures such as DCOM, CORBA, Web objects, Web Services or similar. The storage device 23 may be a hard drive, magnetic drive, optical drive, portable drive, or nonvolatile memory drive. The drives and associated computer-readable media thereof (if required) provide nonvolatile storage of computer-readable instructions, data structures and program modules. The communication device 26 may be a wired network adapter or a wireless network adapter compatible with GPRS, 802.x, Bluetooth and the like.

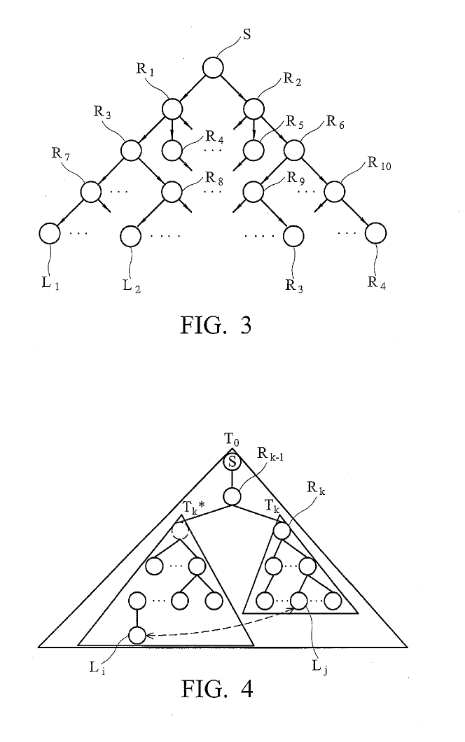

A distributed event dissemination mechanism is employed for efficiently transmitting event notifications to personal computers and electronic devices when the subscribing personal computers and electronic devices are part of a large-scale distributed network environment. FIG. 3 is a diagram of an embodiment of a distributed event dissemination mechanism. All personal computers and electronic devices are organized into an event casting tree. Event notifications are delivered in a cascading manner from the top to down. An event casting tree consists of three types of nodes: a unique root node (e.g. S of FIG. 3); relay nodes (e.g. R₁ to R₁₀); and leaf nodes (e.g. L₁ to L₄). The root node S represents a personal computer or electronic device containing a service which is the event sender for transmitting event notifications to leaf nodes via numerous relay nodes. The leaf nodes L₁ to L₄ and others are event receivers for subscribing to the event notification service of the event sender. The relay nodes R₁ to R₁₀ and others are in-between nodes among the root node S and leaf nodes L₁ to L₄ and others. The relay nodes may be personal computers, electronic devices or network devices such as wireless access points, base stations, hubs, bridges, routers, gateways or similar.

An event notification may be organized by the following format:

```
Event notification
    service_identifier  sid;
    service_location_reference  slr;
    relay_node_identifier rid;
    state  sValue;
    versionvValue;
    time  tValue;
    duration  dValue;
```

An event notification includes several data fields such as a service identifier (sid), a service location reference (slr), a relay node identifier (rid), a service state value (sValue), a version identifier (dValue), a time at which the event notification is generated (tValue) and a valid duration (dValue). The version identifier (ID) differentiates an individual event (i.e. service state value) from multiple events. The version ID may be represented in a form of a service ID hyphenated by an event ID, organized in the following format:

version ID:=“service ID”−“event ID”.

The relay node identifier initiated as “null” is encapsulated in the first event notification sent by the root node to its child relay nodes. When receiving an event notification, a relay node appends its identifier to the relay node identifier of the received event notification and transmits the revised event notification to its child relay nodes or leaf nodes. In addition, the relay node records a tuple of parent node identifier and sid, vValue and sValue of the received event notification in a local database, denoted as <sid, parent's rid, vValue, sValue>. When receiving an event notification, a leaf node records a tuple of sid, slr, parent node rid (or the root node), vValue and sValue of the received event notification, denoted as <sid, slr, parent's rid, vValue, sValue>.

Two leaf nodes may have different versions of service state values corresponding to an identical service in course of service coordination. There exist many causes that can induce inconsistent states among leaf nodes. For example, a broken relay node temporarily interrupts event notification transfer or occurs data transmission jam between two nodes, such as two relay nodes, a root node and a relay node, or a relay node and a leaf node. FIG. 4 is a diagram of state inconsistency among leaf nodes. An event casting tree To has a root node S and relay nodes Rₖ₋₁, Rₖ* and Rₖ, the root node connects to the relay node Rₖ₋₁ as its child node, and the relay node Rₖ₋₁ connects to two relay nodes Rₖ* and Rₖ as its child nodes. When the relay node Rₖ* experiences an exceptional error, event notification can not be downwardly transmitted to all relay nodes and leaf nodes via the relay node Rₖ*, resulting in state inconsistency between sub-trees Tₖ* and Tₖ. When leaf nodes Lᵢ and Lⱼ inspect cached version IDs of service state values for service coordination and collaboration, it is detected that the version ID owned by the leaf node Lᵢ is older than that owned by the leaf node Lⱼ.

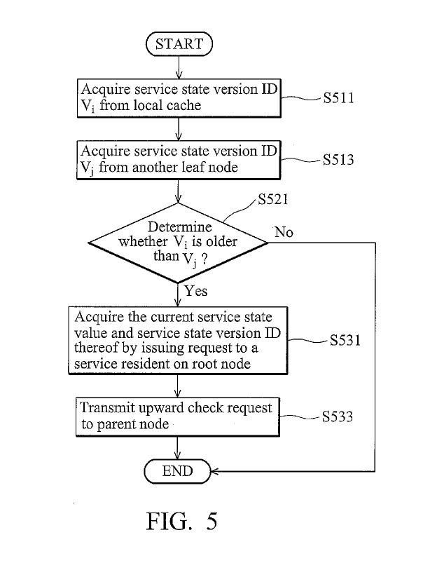

FIG. 5 is a flowchart of an embodiment of a state synchronization method executed by a leaf node such as Lᵢ or Lⱼ of FIG. 4. In step S511, a service state version ID Vᵢ corresponding to the newest service state value is acquired from a local cache. The local cache may be implemented in the memory 22 or storage device 23 (FIG. 2). In step S513, a service state version ID Vⱼ is acquired from another leaf node, which Vⱼ corresponds to the newest service state value stored in a local cache of another leaf node. In step S521, it is determined whether Vᵢ is older than Vⱼ. If so, the process proceeds to step S531, otherwise, the process ends. In step S531, the current service state value and service state version ID thereof are queried by issuing a request to a service resident on the root node S (FIG. 3 or 4). In step S533, an upward check request comprising the current service state value and service state version ID thereof acquired from the root node is transmitted to a parent node (may be a relay node or the root node). The parent node identifier may be acquired from its local cache.

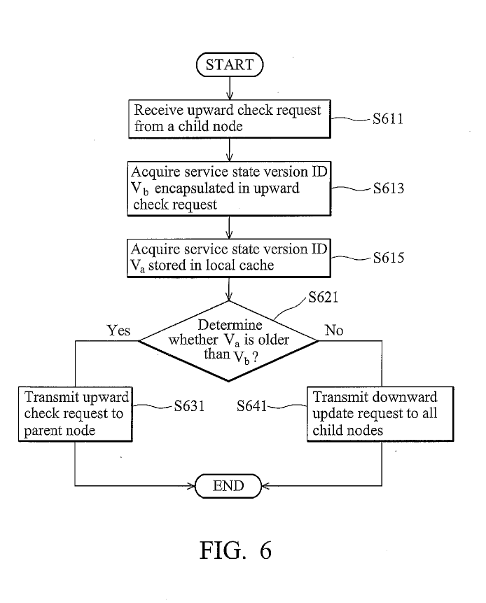

FIG. 6 is a flowchart of an embodiment of a state synchronization method executed by a relay node or the root node, such as one of S, R₁ to R₁₀ of FIG. 3. In step S611, an upward check request is received from a child node. In step S613, a service state version ID V_{b} encapsulated in the upward check request is acquired. In step S615, a service state version ID Vₐ stored in a local cache is acquired, where Vₐ corresponds to the current service state value stored in the local cache. In step S621, it is determined whether Vₐ is older than V_{b}. If so, the process proceeds to step S631, otherwise, to step S641. In step S631, an upward check request comprising a service state value and the service state version ID V_{b} thereof acquired from the previously received upward check request is transmitted to a parent node (may be a relay node or the root node). The parent node identifier may be acquired from its local cache. In step S641, a downward update request comprising a service state value and the service state version ID V_{b} thereof acquired from the previously received upward check request is transmitted to all child nodes (may be relay nodes and/or leaf nodes).

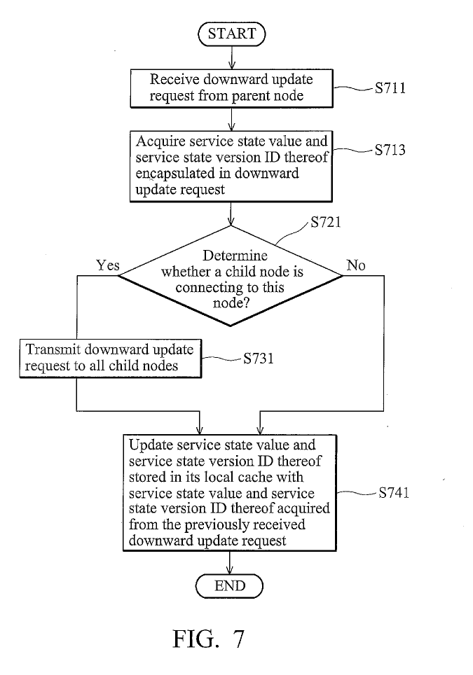

FIG. 7 is a flowchart of an embodiment of a state synchronization method executed by a relay node or a leaf node, such as one of R₁ to R₁₀ and L₁ to L₄ of FIG. 3. In step S711, a downward update request is received from a parent node. In step S713, a service state value and a service state version ID thereof encapsulated in the downward update request is acquired. In step S721, it is determined whether a child node is connecting to this node. If so, the process sequentially proceeds to steps S731 and S741, otherwise, to step S741. In step S731, a downward update request comprising the service state value and the service state version ID thereof acquired from the previously received downward update request is transmitted to all child nodes (may be relay nodes and/or leaf nodes). In step S741, a service state value and a service state version ID thereof stored in its local cache are updated with the service state value and the service state version ID thereof acquired from the previously received downward update request.

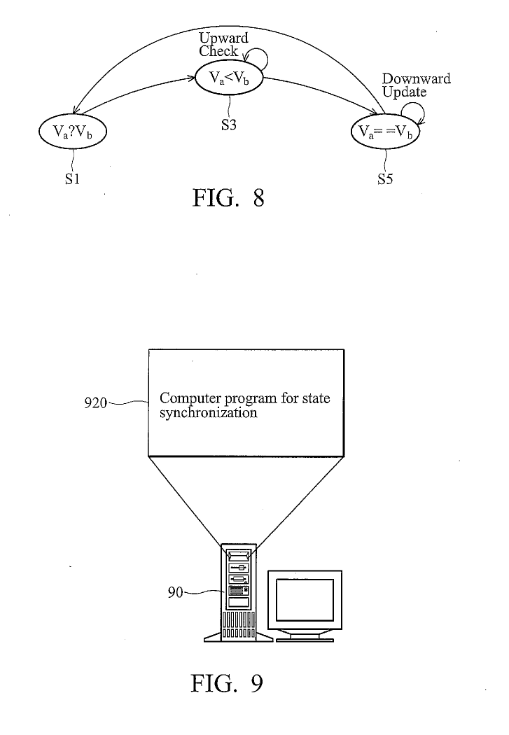

FIG. 8 is a diagram of an embodiment of a finite state machine (FSM) of state synchronization comprising three states S1 to S5. The state S1 comprises actions performed during service coordination and collaboration between two leaf nodes. The details of actions for state S1 may refer to steps shown in FIG. 5. A state S3 is transited to from state S1 when one leaf node detects that a service state version ID thereof is older than a service state version ID owned by the other leaf node. The state S3 comprises actions performed when a relay node or the root node receives an upward check request. The details of actions for state S3 may refer to steps shown in FIG. 6. A state S5 is transited to from state S3 after a relay node or the root node detects that a service state version ID thereof is not older than a service state version ID encapsulated in a received upward check request. The state S5 comprises actions when a relay node or a leaf node receives a downward update request. The details of actions for state S5 may refer to steps of FIG. 7. The state S1 is transited to from the state S5 after a leaf node detects that no child node is connected to itself.

Also disclosed is a storage medium as shown in FIG. 9 storing a computer program 920 providing the disclosed state synchronization methods. The computer program includes a storage medium 90 having computer readable program code therein for use in a computer system. The computer readable program code, when loaded and executed by the processing unit 21 (FIG. 2), performs operations described in FIGS. 5 to 7.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

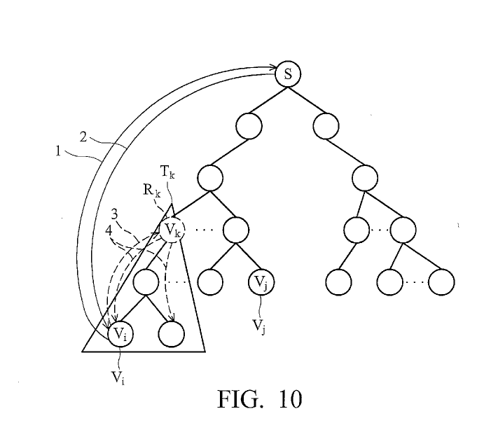

Detailed descriptions of state synchronization methods are provided in the following. FIG. 10 is a diagram of exemplary state synchronization. When a leaf node Lᵢ detects that the owned service state version ID is older than a service state version ID owned by a leaf node Lⱼ, the current service state value and service state version ID thereof are queried by issuing a request to a service resident on the root node S (step S531 of FIG. 5), an upward check request is transmitted to a parent node to activate an upward check procedure transmitting the upward check request to a node causing inconsistency among service state version IDs (S533 of FIG. 5). Referring to the method as shown in FIG. 6, the upward check procedure sequentially transmits the upward check request to a relay node Rₖ. When the relay node Rₖ detects that the owned service state version ID is not older than a service state version ID in the received upward check request, a downward update request is transmitted to all child nodes to activate a downward update procedure (S641 of FIG. 6). The downward update procedure downwardly updates service state values and service state version IDs thereof owned by all child nodes directly or indirectly connecting to the relay node Rₖ. Referring to the method as shown in FIG. 7, all nodes in a subtree Tₖ update service state values and service state version IDs thereof in local caches with a service state value and a service state version ID thereof in the received downward update request (step S741 of FIG. 7).

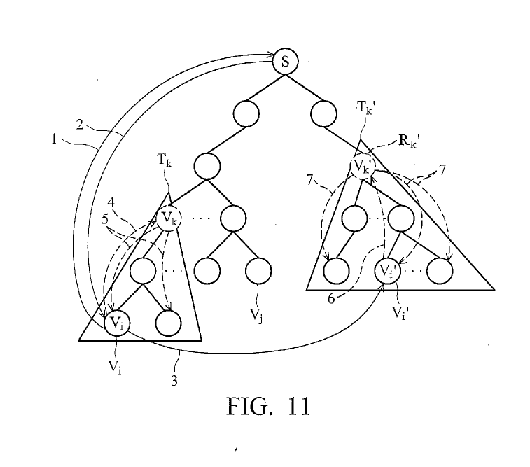

FIG. 11 is a diagram of exemplary state synchronization. Supposing that leaf nodes Lᵢ and Lᵢ′ have the same service state version ID. When a leaf node Lᵢ detects that the owned service state version ID is older than a service state version ID owned by a leaf node Lⱼ, the leaf node Lᵢ not only updates service state values and service state version IDs thereof in all nodes of a subtree Tkₖ by activating a state synchronization mechanism as shown in FIG. 10, but also transmits the acquired service state value and service state version ID thereof to another leaf node Lᵢ′, thereby enabling the leaf node Lᵢ′ to update service state values and service state version IDs thereof in all nodes of a subtree Tkₖ′ by activating the state synchronization mechanism as shown in FIG. 10.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method for state synchronization, performed by a first electronic apparatus, comprising:
acquiring a first service state version identification (ID) from a local cache of the first electronic apparatus;
receiving a second service state version ID from a second electronic apparatus;
determining whether the first service state version ID is older than the second service state version ID; and
acquiring a current service state value and a third service state version ID corresponding to the current service state value by querying a service resident on a third electronic apparatus when the first service state version ID is older than the second service state version ID,
wherein the first, second and third electronic apparatuses are organized in an event casting tree, the third electronic apparatus is a root node of the event casting tree, and the first and second electronic apparatuses are leaf nodes of the event casting tree.

2. The method as claimed in claim 1 further comprising:
activating an upward check procedure by transmitting an upward check request to a fourth electronic apparatus,
wherein the upward check request comprises the current service state value and the third service state version ID, the upward check procedure transmits the upward check request to an electronic device causing inconsistency between the first, second and third service state version IDs, the fourth electronic apparatus is organized in the event casting tree, and the fourth electronic apparatus is a parent node of the first electronic apparatus.

3. The method as claimed in claim 1 further comprising storing the current service state value in the local cache.

4. A method for state synchronization, performed by a first electronic apparatus, comprising:
receiving an upward check request from a second electronic apparatus, the upward check request comprising a first service state version identification (ID);
acquiring a second service state version ID stored in a local cache of the first electronic apparatus; and
selectively activating an upward check procedure and a downward check procedure according to a comparison result between the first service state version ID and the second service state version ID,
wherein the first and second electronic apparatuses are organized in an event casting tree, the first electronic apparatus is a parent node of the second electronic apparatus, the upward check procedure transmits the upward check request to an electronic device causing inconsistency between the first and second service state version IDs, and the downward update procedure downwardly notifies all nodes directly or indirectly connecting to the first electronic apparatus of information indicating storing a first service state value corresponding to the first service state version ID.

5. The method as claimed in claim 4 wherein the selectively activating step further comprises:
transmitting the upward check request to activate the upward check procedure when the second service state version ID is older than the first service state version ID,
wherein the third electronic apparatus is organized in the event casting tree, and the third electronic apparatus is a parent node of the first electronic apparatus.

6. The method as claimed in claim 4 wherein the selective activation step further comprises:
transmitting a downward update request to activate the downward update procedure when the second service state version ID is not older than the first service state version ID,
wherein the third electronic apparatus is organized in the event casting tree, and the third electronic apparatus is a child node of the first electronic apparatus.

7. A method for state synchronization, performed by a first electronic apparatus, comprising:
receiving a downward update request from a second electronic apparatus, the downward update request comprising a first service state version identification (ID) and a service state value corresponding to the first service state version ID;
respectively replacing a second service state version ID and a second service state value in a local cache of the first electronic apparatus with the first service state version ID and the first service state value,
wherein the first and second electronic apparatuses are organized in an event casting tree, and the first electronic apparatus is a child node of the second electronic apparatuses.

8. The method as claimed in claim 7 further comprising:
determining whether a third electronic apparatus being a child node of the first electronic apparatus is present; and
activating a downward update procedure by transmitting the downward update request to the third electronic apparatus when the third electronic apparatus is present,
wherein the downward update procedure downwardly notifies all nodes directly or indirectly connecting to the first electronic apparatus of information indicating storing the first service state version ID and the first service state value.

9. A system for state synchronization, comprising:
a first electronic apparatus comprising a service;
a second electronic apparatus; and
a third electronic apparatus,
wherein the first, second and third electronic apparatuses are organized in an event casting tree, the first electronic apparatus represents a root node of the event casting tree, the second electronic apparatus represents a relay node of the event casting tree, the third electronic apparatus represents a leaf node of the event casting tree, the third electronic apparatus subscribes to a plurality of event notifications from the service, and the first electronic apparatus hierarchically transmits the event notifications in sequence to the third electronic apparatus via the second electronic apparatus.

10. The system as claimed in claim 9 wherein each event notification comprises a service state value and a service state version identification (ID) corresponding to the service state value.

11. The system as claimed in claim 9 wherein the third electronic apparatus acquires a first service state version identification (ID) from a local cache of the first electronic apparatus, receives a second service state version ID from a fourth electronic apparatus, determines whether the first service state version ID is older than the second service state version ID, and acquires a current service state value and a third service state version ID corresponding to the current service state value by querying a service resident on the first electronic apparatus when the first service state version ID is older than the second service state version ID, and the fourth electronic apparatus represents a leaf node of the event casting tree.

12. The system as claimed in claim 11 wherein the third electronic apparatus activates an upward check procedure by transmitting an upward check request to the second electronic apparatus, the upward check request comprises the current service state value and the third service state version ID and the upward check procedure transmits the upward check request to an electronic device causing inconsistency between the first, second and third service state version IDs.

13. The system as claimed in claim 11 wherein the third electronic apparatus stores the current service state value in the local cache thereof.

14. The system as claimed in claim 9 wherein the second electronic apparatus receives an upward check request from a child node of the second electronic apparatus, the upward check request comprises a first service state version ID, the second electronic apparatus acquires a second service state version ID stored in a local cache of the first electronic apparatus and selectively activates an upward check procedure and an downward check procedure according to a comparison result between the first service state version ID and the second service state version ID, the upward check procedure transmits the upward check request to an electronic device causing inconsistency between the first and second service state version IDs, and the downward update procedure downwardly notifies all nodes directly or indirectly connecting to the second electronic apparatus of information indicating storage of a first service state value corresponding to the first service state version ID.

15. The system as claimed in claim 14 wherein the second electronic apparatus transmits the upward check request to a parent node of the second electronic apparatus in order to activate the upward check procedure when the second service state version ID is older than the first service state version ID.

16. The system as claimed in claim 14 wherein the second electronic apparatus transmits the downward update request to all child nodes of the second electronic apparatus in order to activate the downward update procedure when the second service state version ID is not older than the first service state version ID.

17. The system as claimed in claim 9 wherein the second electronic apparatus receives a downward update request from a parent node of the second electronic apparatus, the downward update request comprises a first service state version identification (ID) and a service state value corresponding to the first service state version ID, and the second electronic apparatus respectively replaces a second service state version ID and a second service state value in a local cache of the second electronic apparatus with the first service state version ID and the first service state value.

18. The system as claimed in claim 17 wherein the second electronic apparatus determines whether a child node of the second electronic apparatus is present and activates a downward update procedure by transmitting the downward update request to all child nodes of the second electronic apparatus when the child node of the second electronic apparatus is present, and the downward update procedure downwardly notifies all nodes directly or indirectly connecting to the second electronic apparatus of information indicating storing the first service state version ID and the first service state value.
